(19) United States
(12) Patent Application Publication
(10) Pub. No.: US 2013/0126197 A1
(43) Pub. Date: May 23, 2013

(54) Reversible Drive Socket or Bit Holder With One-Way Clutch Mechanism

(71) Applicants: John C. Lisle, Clarinda, IA (US); Scotty R. Kurtz, Clarinda, IA (US)

(72) Inventors: John C. Lisle, Clarinda, IA (US); Scotty R. Kurtz, Clarinda, IA (US)

(73) Assignee: Lisle Corporation, Clarinda, IA (US)

(21) Appl. No.: 13/303,647

(22) Filed: Nov. 23, 2011

(51) Int. Cl. B25B 13/46

(52) U.S. Cl. 173/1; 81/63.1

(57) ABSTRACT

A finger operable, reverse drive holder tool includes an annular knob or handle with a one-way clutch axially retained within the handle and capable of removably receiving a selected holder having a uniform or standard sized body which is insertable into the one-way clutch and may be easily removed and reversed by insertion into the opposite side of the one-way clutch.

### BACKGROUND OF THE INVENTION

In a principal aspect the invention relates to a manually operable, reversible drive, socket holder or bit holder.

Mechanics and tradesman often need to insert or remove fasteners in locations that are difficult to access. In such circumstances, wrenches such as long handled, crescent wrenches, socket wrenches and ratchet type wrenches may not be acceptable or useful because they will not fit into a restricted working space.

To overcome this problem, small finger operated wrench mechanisms have been proposed. For example, Cal-Van Tools disclose a set of socket type wrenches which incorporate a socket in a small, disc shaped retainer or handle. The retainer or handle may be manually manipulated to cause rotation of the socket. The wrenches are not reversible and must therefore be manipulated by manual rotation in a first rotational sense or an opposite, second, reverse rotation sense depending upon whether a fastener is being inserted or removed by the wrench tool.

Ratchet drives have also been miniaturized. For example, Titan Industries discloses a finger operated ratchet mechanism for a socket drive. Snap-On Tools also offers a finger operated ratchet tool having various socket sizes and configurations.

While such tools are quite useful and to some extent popular for performing a mechanical activity in a restricted space, nonetheless reversible ratchet type tools are typically bulky, difficult to use, may be restricted to single size socket and difficult to adjust. Thus, there has developed a need for an improved, finger operated, reversible universal bit or socket holder.

### SUMMARY OF THE INVENTION

Briefly the invention comprises a finger operable, reversible drive socket or bit holder tool. The tool includes a generally annular, actuating knob or body member or handle with a throughbore that extends axially entirely through the body member. A one-way, annular shaped clutch mechanism is incorporated in or mounted in the throughbore. The one-way clutch mechanism may include a generally cylindrical frame inserted into and maintained in the handle throughbore. A separate bit holder or socket holder may be slidably inserted into an axial passageway extending through the one-way clutch mechanism. Thus a selected holder may be axially, partially inserted into the axial passageway of the clutch mechanism by a flange on the holder which limits axial insertion of the holder into the axial passageway and held or retained therein a biasing or friction element fitted into and/or substantially through the axial passageway. The biasing or friction element provides a means to frictionally retain the holder in the passageway of the one-way clutch mechanism by restraining axial movement of the holder once the holder is inserted into the passageway. At least one end of the holder may project axially in an outward direction from the flange. The holder, depending upon its design, may thus support a socket or receive a bit. The actuating knob or body member may then be manually rotated about the axis of the holder.

Importantly, the one-way clutch mechanism grips the inserted holder following initial rotation of the annular body member in a first sense thereby enabling further manual manipulation of the annular body member and the holder (and attached socket or bit) about the holder axis in a first sense only but not in a second or opposite, freewheeling sense. To reverse the rotational actuating operation, the holder is removed from engagement by axially withdrawing it from the one-way clutch mechanism passageway and then reinserting that bit holder into the opposite side of the axial passageway of the one-way clutch mechanism in the body member or actuating handle. Various types or styles of holders may thus be inserted into the passageway of the one-way clutch. The holder may be configured to comprise a socket holder or a bit holder or otherwise configured to engage a fastener or some other element such as a lock or latch. Thus, the holder may be in the form of a socket holder or a bit holder or in the form of a tool such as a screw driver.

An objective and aspect of the invention is to provide a tool having a one-way clutch mechanism capable of use in combination with numerous sizes and designs of holders.

A further object of the invention is to provide a manually operable bit or socket holder tool which enables reversibility of the operation of the holder whereby the tool may be used, for example, to either insert or drive a fastener as well as remove or reversible rotate a fastener.

Another object and feature of the invention is to provide a compact yet rugged and inexpensive reversible drive holder tool that may be manually operated and used in restricted spaces.

Another object of the invention is to provide a tool which incorporates a selected, holder having a generally cylindrical body member that interacts with a one-way clutch mechanism in a finger actuable knob or handle and which further incorporates means for retaining the holder engaged with the one-way clutch mechanism, during use, and also enables easy removal of the holder from the clutch mechanism and replacement with another distinct holder or removal of the holder and reversible reinsertion thereof into the handle.

Another object of the invention is to provide a tool with a one-way clutch mechanism which is cooperative with and enables engagement of the holder for rotational movement thereof in either rotational sense about the axis of the holder.

These and other objects, advantages and features of the invention will be set forth in the detailed description which follows.

### BRIEF DESCRIPTION OF THE DRAWING

In the detailed description which follows reference will be made to the drawing comprised of the following figures:

FIG. 1 is an exploded, isometric view of an embodiment of the invention;

FIG. 2 is a side elevation of the embodiment of FIG. 1;

FIG. 3 is an end view of the embodiment of FIG. 2;

FIG. 4 is a side elevation a holder included in of the embodiment of FIG. 1;

FIG. 5 is an end view of the holder of FIG. 4;

FIG. 6 is an end view of a one-way clutch mechanism for the embodiment of FIG. 1;

FIG. 7 is a cross sectional view of the one-way clutch mechanism of FIG. 6 taken along the line 7-7;

FIG. 8 is a side elevation of an alternative embodiment;

FIG. 9 is an end view of the tool of FIG. 8;

FIG. 10 depicts a side view of the bit holder for the embodiment of FIG. 8;

FIG. 11 is an end view of the bit holder of FIG. 10;

FIG. 12 is a side elevation of yet another embodiment of the tool;

FIG. 13 is an end view of the tool of FIG. 12;

FIG. 14 is a side elevation of an alternate double ended socket holder embodiment;

FIG. 15 is a side elevation of a further alternate bit holder embodiment;

FIG. 16 is a plan view of an actuating knob or manual handle of the type depicted in the embodiment of FIG. 1;

FIG. 17 is a side elevation of the knob of FIG. 16;

FIG. 18 is a plan view of an alternate construction of an actuating knob;

FIG. 19 is a side elevation of the actuating knob of FIG. 18;

FIG. 20 is a plan view of yet another actuating knob;

FIG. 21 is a side elevation of the actuating knob of FIG. 20;

FIG. 22 is a plan view of an embodiment of an actuating knob; and

FIG. 23 is a side elevation of the actuating knob of FIG. 22 also illustrating a bracket which may be used in combination therewith.

### DETAILED DESCRIPTION OF EMBODIMENTS OF THE INVENTION

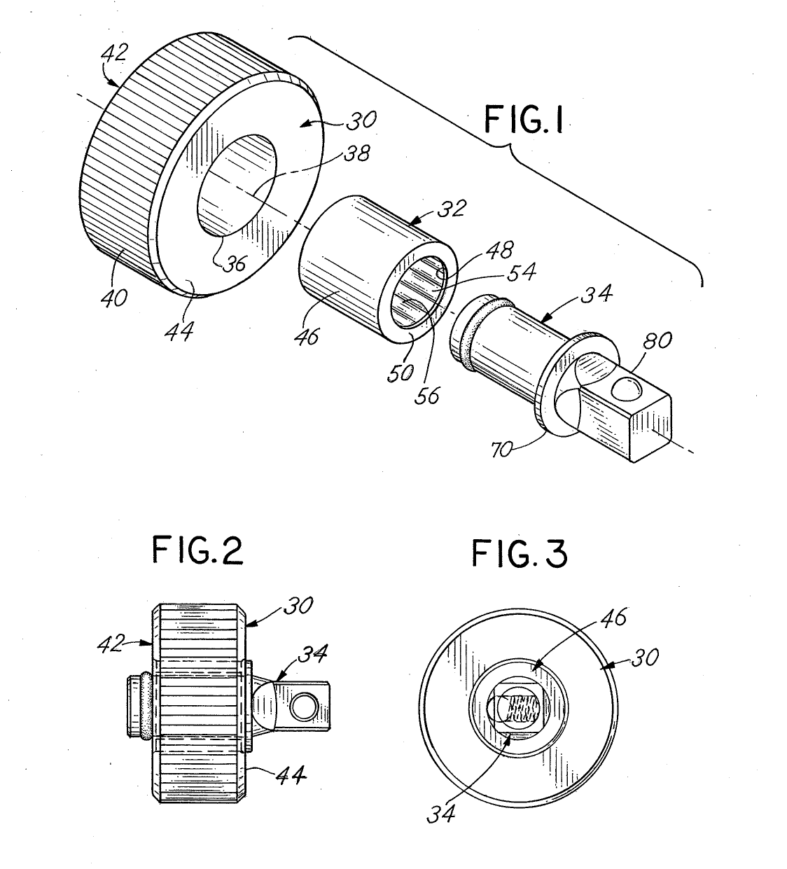

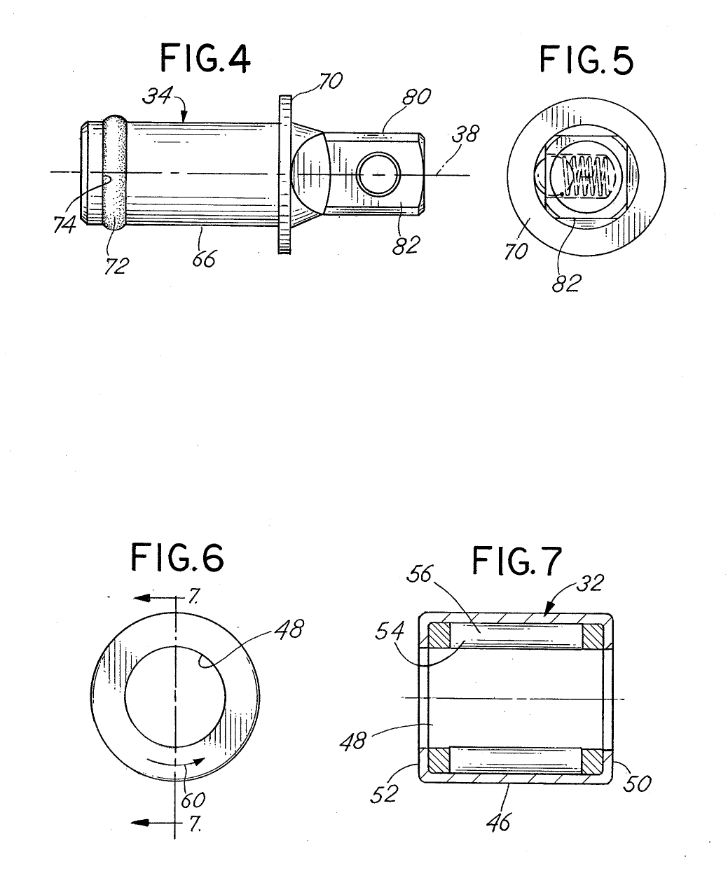

FIGS. 1-7 generally illustrate a first embodiment of the invention including the various component parts of the mechanism which comprise the invention. The remaining FIGS. 10-23 illustrate alternative embodiments, aspects and features of the invention.

Referring to FIGS. 1-7, a manually operable, reversible socket holder tool is comprised of three component parts. An annular actuating knob or handle 30 incorporates a one-way clutch assembly 32. The combination of the annular knob or handle 30 and clutch assembly 32 cooperate with a separable, component holder assembly, for example, socket holder 34. That is, holder assemblies of various size and design may be utilized in combination with the unitary or integrated or combined actuating knob or handle 30 and one way clutch assembly 32. Holder assemblies may, for example, comprise a socket holder or a bit holder or another tool that is insertable in the knob or handle 30.

In the embodiment depicted the annular knob or handle 30 includes an axial, uniform diameter, cylindrical throughbore 36 having a centerline axis 38. The handle 30 further includes an outer face or generally co-axial, cylindrical surface 40, a first outside generally planar face 42 which is transverse to the centerline axis 38 and a second outer surface or generally planar face 44 which is generally parallel to the first face 42 and transverse to the centerline axis 38. The actuating annular knob or handle 30 is sized so that it may easily be grasped on its outer surface 40 by the fingers of a mechanic or operator and rotated about the axis 38. The axial throughbore 36 is sized to receive the one-way clutch assembly 32 and, more particularly, to receive and retain a clutch housing 46 of the clutch assembly 32.

The clutch assembly 32 comprises the cylindrical clutch housing 46 with a through passage 48 that, when assembled with the actuating annular knob or handle 30, is coaxial with the axis 38 of the throughbore 36. The one-way clutch assembly 32 and, more particularly, the clutch housing 46 includes transverse end flanges 50 and 52 to facilitate the retention of a one-way clutch mechanism 54. The one-way clutch mechanism 54 typically includes multiple rollers, such as rollers 56, which interact with a cylindrical member that may be inserted in the passageway or axial passageway 48 to cause gripping of a cylindrical member inserted therein upon rotation in one sense but release of gripping when rotated in the opposite sense. A typical example of such a clutch assembly 32 is generally identified as the HF version one-way clutch. An arrow in FIG. 6 illustrates the rotational sense 60 imparted to an inserted cylindrical member or element or item positioned in the through passage 48 to thereby enable such an inserted cylindrical member to be engaged and gripped by the clutch mechanism 54. A reversal to the indicated direction releases the item or member or element gripped by the rollers, such as rollers 56, of the clutch mechanism 54.

A typical socket holder 34 is comprised of a generally cylindrical body 66 which is symmetrical about a centerline axis 39. The cylindrical body 66 is sized to fit through the axial passageway or through passage 48 of the one-way clutch mechanism 54 of clutch assembly 32. Thus, the diameter of the holder 34 and, more particularly, the body 66 is chosen so that when the sides of the body 66 engage the rollers 56 and the handle 30 is appropriately rotated about axis 39, the rollers 56 will tighten and retain the body 66 effectively locked in position. Thus rotation of the annular knob or handle 30 in a first sense causes the entire assembly including the holder 34 to rotate in the desired sense or direction. Reverse rotation is, however, freewheeling. That is, as an aspect of the use or benefit associated with the use of a one-way clutch, reversal of rotation from an actuating sense to a freewheeling sense avoids drag forces on the holder that may cause reverse rotation of a fastener engaged by the holder. This is in contrast to a ratchet mechanism which tends to exhibit reverse drag and thus is not necessarily as freewheeling in the reverse rotational sense as embodiments of the present invention.

The holder 34 further includes a flange 70 at one end of the body 66 and an elastomeric or other type of retention member or releasable biasing element such as an O-ring 72 that fits into a groove 74 in or near the opposite end of the body member 66. The spacing of the flange 70 and the O-ring and groove 72, 74 are chosen to approximate the spacing of the first face 52 from the second face 50 of the clutch assembly 32. In this manner, the O-ring or biasing element 72 will be enabled to slip through the axial through passage 48 and seat against the face 52 while the flange 70 will be seated generally on or generally at the face 50 of the clutch assembly 32. The holder 34 is thus retained in a removable but relatively stable position within the annular knob or handle 30. The biasing force associated with the O-ring or another biasing element will tend to retain the holder 34 in position but will not preclude its axial removal.

The holder 34 may include a projecting or end section or member 80 which is generally coaxial with the body 66 and which projects axially from flange 70 or is located to enable access for engagement by a socket or a bit or some other type of tool element. The projecting section 80 is configured to engage or receive a socket, for example, as a polygonal driver 82. Upon insertion of the holder 34 through the axial passageway 48, and attachment of a selected tool element, manipulation of the tool is effected by manually turning the actuating annular knob or handle 30 in the direction of the arrow in FIG. 6. The tool may, for example, drive a fastener when so manipulated. To release the holder 34 from engagement with the clutch assembly 32 and permit freewheeling rotation of the holder 34, the direction of rotation of knob 30 is reversed.

To reverse the driving or working operation of the tool, one must merely remove the socket holder 34 from the clutch assembly 32 and reinsert the holder 34 axially into passage 48 opening at the first face 52 rather than depicted in FIG. 1 as being inserted into the opening of passage 48 initially through the second face 50. In this manner, the effective working rotational sense of the tool is reversed as is the freewheeling operation.

The tool, thus, avoids the problems a tradesperson or mechanic would potentially encounter with a ratchet mechanism wherein accidental touching of the ratchet control may cause inadvertent reversal of the sense of operation of the tool. The present invention provides a very positive and continuous application of rotational continuity because of incorporation of a one-way clutch mechanism. That is, the socket holder or assembly 34 must be inserted initially axially into the clutch or clutch assembly 32 to lock or retain the holder 34 for rotation in a first sense, and must be removed and reinserted axially into the opposite side of knob or handle 30 to reverse the effective locked rotational sense of operation.

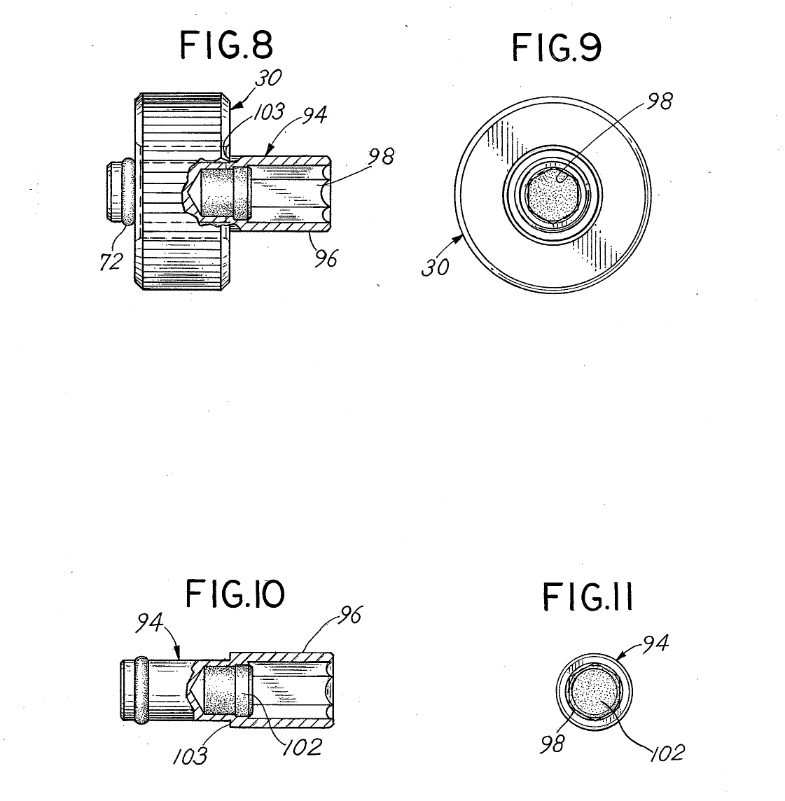

FIGS. 8, 9, 10 and 11 illustrate an alternative holder or holder assembly 94 in combination with a handle or actuating annular knob 30. The assembly 94 includes the O ring 74 which serves to retain the assembly 94 in position. A section 96 of the assembly 94 includes a counterbore having an internal configuration of a socket 98. The socket 98 is sized to provide a flange 103 which limits the insertion of the assembly 94 into a one way clutch of an annular knob or handle 30. FIG. 10 depicts a construction of the assembly 94. That is, the assembly 94 may include a body with a bore having a magnet 102 mounted therein to maintain and hold a bit (not shown).

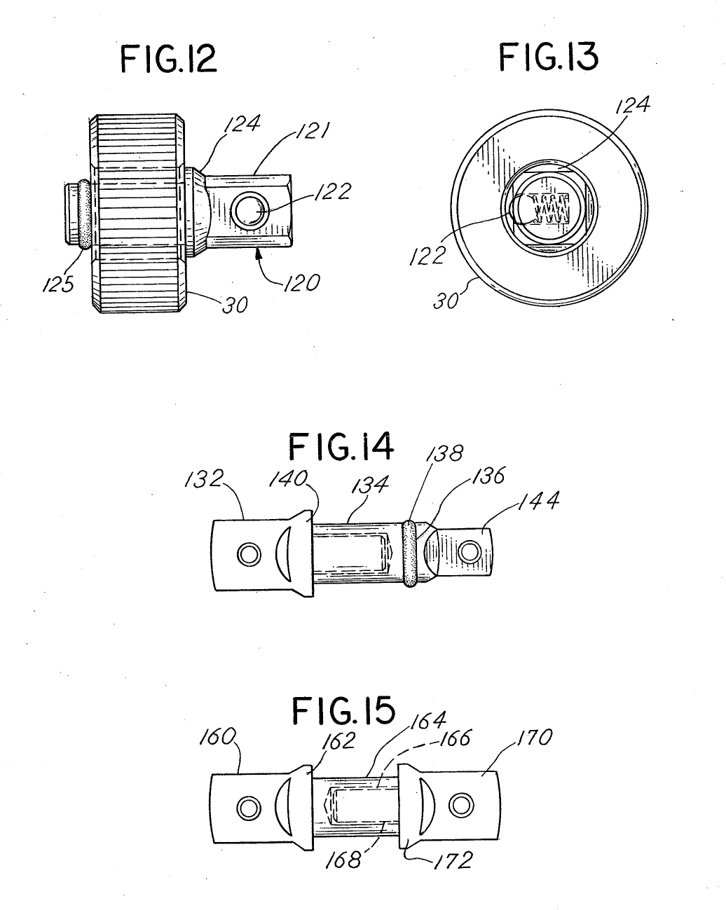

FIGS. 12 and 13 illustrate a further optional construction of a holder and tool of the invention. A body member includes an O-ring 125 at one end of the body member. The holder 120 further includes a projection 121 at the opposite end with a spring biased retainer ball 122 such that a further fastener tool such as a socket or the like may be attached thereto. A flange 124 incorporated in the holder 120 limits the insertion of the section 121 into the handle or knob 30.

FIG. 14 illustrates a further option. An assembly includes a socket mount 132 at one end, a central body 134, a groove 136 with an O-ring 138 spaced from the flange 140. The end adjacent the O-ring 138 is sized to cooperate with a different sized socket mount 144. Thus the socket mount 144 is sized so that it will fit through the axial passageway in the one-way clutch and handle 30 and is also dimensioned so that it will act as a socket holder or mount.

FIG. 15 illustrates a further optional construction of an assembly or holder. The holder assembly is comprised of a socket holder 160 which includes a flange 162 that is joined to a body 164. The body 164 includes a bore or counterbore 166 into which a projecting rod 168 of a second separate socket receiver 170 is provided. The second socket receiver 170 includes a flange 172. The flanges 162 and 172 fit on opposite sides of the clutch assembly 32 in opposition to the first and second surfaces 50, 52 respectively. The component parts of the assembly of FIG. 15 may be friction fitted together or they may comprise the opposite poles of a magnet. Various other alternative means to ensure their joinder may be adopted.

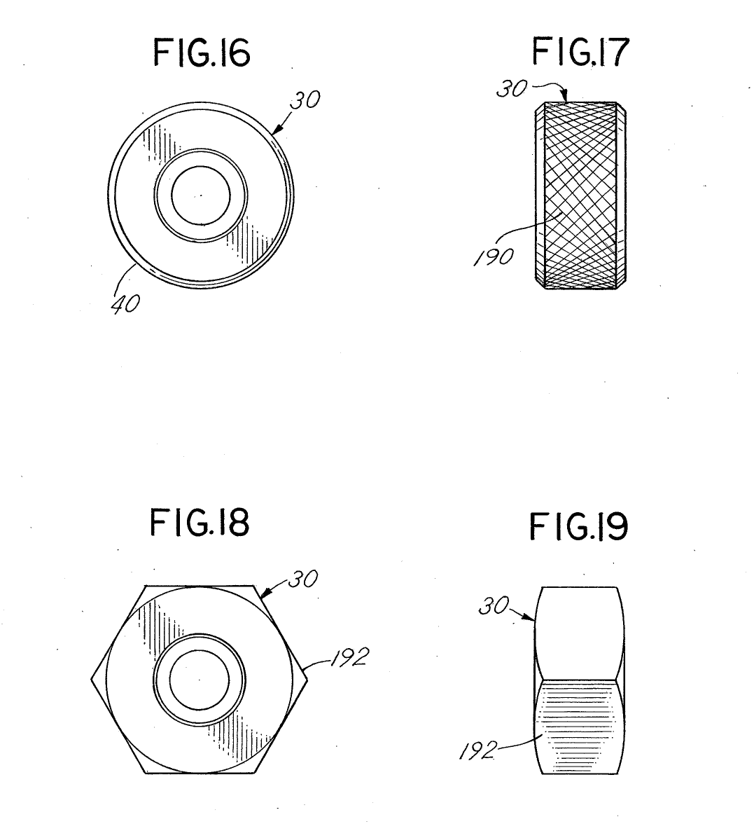

FIGS. 16-23 illustrate a series of optional constructions for the annular knob or handle 30. In FIGS. 16 and 17 illustrate inclusion of cross hatching or a knurl construction 190 of the outside face or surface 40.

FIGS. 18 and 19 illustrate an alternative configuration for the outside surface. Namely, a polygonal outside surface 192 is provided. An oversized socket may be engaged over the outside surface 192 or a wrench may be utilized.

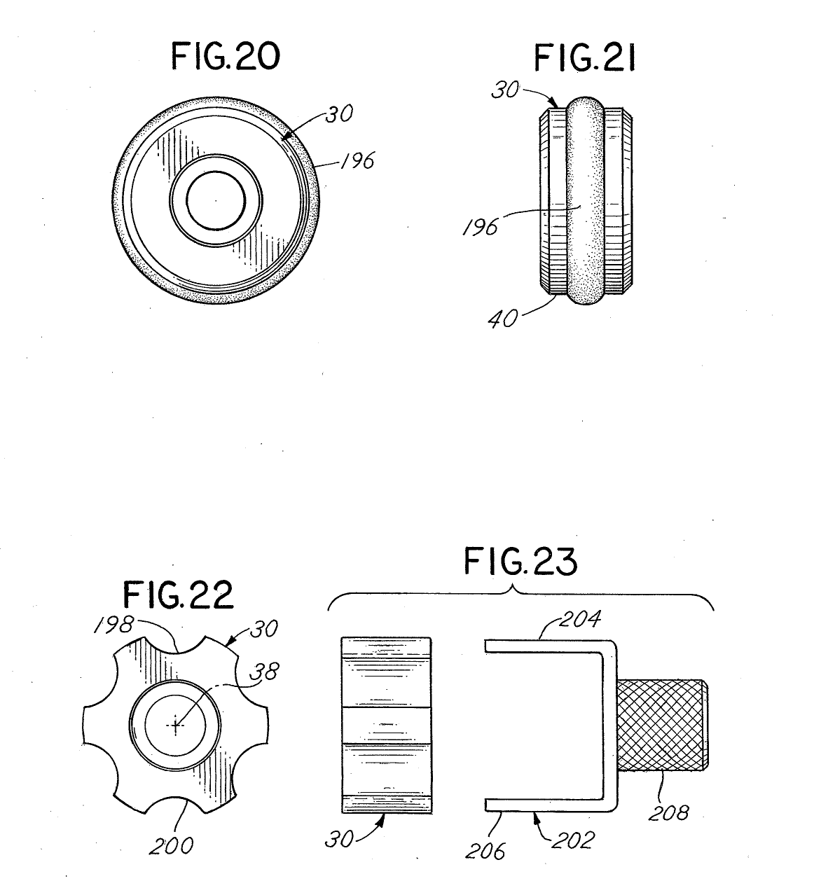

FIGS. 20 and 21 illustrate another configuration of the handle 30. A rubber or elastomeric outer rim 196 is provided on the outside surface 40 to facilitate the grip and rotatably of the tool.

FIGS. 22 and 23 illustrate a further handle configuration. The handle 30 includes scalloped sections such as the scallops 198 and 200 which are arranged in opposed array on opposite sides of axis 38. In order to enhance the utility of this particular arrangement, a U-shaped bracket 202 may be used with the arms 204 and 206 of the bracket 202 inserted into opposed scalloped sections 198 and 200. The U-shaped bracket 202 may include, for example, a central plate 208 which may be gripped to effect rotation of the knob or annular handle 30.

A myriad of alternative features may therefore be incorporated within the socket holder or a bit holder assembly as well as with respect to the knob or handle. For example, the handle or knob and clutch assembly may be a unitary component. In any event, the utilization of a one-way clutch is an important feature of the invention inasmuch as it provides for a positive interaction and positive gripping action in a desired rotational sense depending upon the manner of combining a holder with the handle or knob 30 and clutch assembly. Further, various ancillary component parts and/or holder may be utilized in combination with the tool as described. The invention is therefore limited only by the following claims and equivalents thereof.

What is claimed is:

1. A finger operable, reversible drive socket holder or holder tool comprising:
a handle having a centerline axis, an outer circumferential surface, first and second spaced end faces generally transverse to the axis, and an axial throughbore;
a one-way clutch assembly including a generally cylindrical clutch housing and an internal one-way clutch mechanism with an axial open ended passage, said one-way clutch assembly generally coaxially located in said throughbore of said handle; and
a separate driver assembly removably insertable in the axial passage of the clutch mechanism, said drive assembly including a generally cylindrical body having a circumferential surface for locking clutch engagement with said clutch mechanism upon rotation of said body about the axis of said passage in one rotational sense and for freewheeling movement in the opposite rotational sense, said body having an axial dimension greater than the axial dimension of said axial passage,
said body further including a releasable biasing element at a first axial location on said body for maintaining said body generally retained in a fixed axial position in said passage and a flange at a second axial location on said body for precluding axial movement of said body in said axial passage whereby the body may alternately be inserted and maintained in the axial passage or removed from the axial passage,
at least one end of said body member including a projecting tool element, whereby the tool element may be engaged and rotated about the axis in only said one rotational sense and further wherein said body member is reversibly insertable in said axial passage to alter the sense of driven rotation by manual rotation of said handle.

2. The tool of claim 1 wherein said holder is selected from the group consisting of a socket receiver and a driver.

3. The tool of claim 1 wherein said body includes a second tool element projecting axially in the direction opposite the tool element and has a maximum diametral dimension no greater than the maximum diametral dimension of said body.

4. The tool of claim 3 wherein said second tool element is selected from the group consisting of a socket receiver and a driver.

5. The tool of claim 1 wherein said biasing element of said body comprises an elastomeric member.

6. The tool of claim 5 wherein said elastomeric member comprises an O-ring.

7. The tool of claim 6 wherein said body includes a circumferential groove for the O-ring.

8. The tool of claim 1 wherein the handle has generally annular configuration.

9. The tool of claim 1 wherein the handle outer surface includes a plurality of radially spaced grooves generally parallel to the axis.

10. The tool of claim 1 wherein the handle outer surface has a polygonal configuration.

11. The tool of claim 1 wherein the handle outer surface includes a friction surface element.

12. The tool of claim 11 wherein the friction surface element comprises an elastic material.

13. The tool of claim 1 wherein said clutch assembly comprises a separate component affixed in a axial passage of said handle.

14. A method for driving a fastener in either rotational sense comprising the steps of:
providing a finger operable reversible drive holder comprising:
a handle having a centerline axis of symmetry, an outer circumferential surface, first and second spaced end faces generally transverse to the axis; and an axial throughbore;
a one-way clutch assembly including a generally cylindrical clutch housing and an internal one-way clutch mechanism with an axial open ended passage, said one-way clutch assembly generally coaxially located in said throughbore of said knob; and
a separate holder assembly removably insertable in the axial passage of the clutch mechanism, said holder assembly including a cylindrical body having a circumferential surface for locking clutch engagement with said clutch mechanism upon rotation of said body about the axis thereof in one rotational sense and for freewheeling movement in the opposite rotational sense, said body having an axial dimension greater than the axial dimension of said axial passage,
said body further including a releasable biasing element at a first axial location on said body for maintaining said body generally retained in a fixed axial position in said passage and a flange at a second axial location on said body for precluding axial movement of said body in said passage whereby the body may alternately be inserted and maintained in the axial passage or removed from the axial passage,
at least one end of said body member including a projecting tool element, whereby the tool element may be engaged and rotated about the axis in only said one rotational sense and further wherein said body member is reversibly insertable in said axial passage;
inserting said body member in said axial passage to provide a fastener tool operable by rotation in a first sense;
engaging a fastener with said tool element; and
axially rotating said fastener in said first sense.

15. A finger operable, reversible drive socket holder tool comprising:
a handle having a centerline axis, an outer circumferential surface, first and second spaced end faces generally transverse to the axis;
a one-way clutch assembly including an internal one-way clutch mechanism with an axial open ended through passage, said one-way clutch assembly generally coaxially located in said handle; and
a separate driver assembly removably insertable in the axial passage of the clutch mechanism, said drive assembly including a generally cylindrical body having a circumferential surface for locking clutch engagement with said clutch mechanism upon rotation of said body about the axis of said passage in one rotational sense and for freewheeling movement in the opposite rotational sense, said body having an axial dimension greater than the axial dimension of said axial through passage,
said body further including a releasable body retention mechanism body for maintaining said body generally retained in a fixed axial position upon insertion into said axial through passage whereby the body may alternately be inserted and maintained in the axial passage or removed from the axial passage,
at least one end of said body member including a projecting tool element, whereby the tool element may be engaged and rotated about the axis in only said one rotational sense and further wherein said body member is reversibly insertable in said axial through passage to alter the sense of driven rotation by manual rotation of said handle.
